(19) United States
(12) Patent Application Publication
(10) Pub. No.: US 2025/0355664 A1
(43) Pub. Date: Nov. 20, 2025

(54) SYSTEMS AND METHODS FOR LAUNCHING A MICRO APP ASSOCIATED WITH A USER INTERFACE

(71) Applicant: The PNC Financial Services Group, Inc., Pittsburgh, PA (US)

(72) Inventor: Charles Keith CARNIE, III, Pittsburgh, PA (US)

(73) Assignee: The PNC Financial Services Group, Inc., Pittsburgh, PA (US)

(21) Appl. No.: 19/207,964

(22) Filed: May 14, 2025

Related U.S. Application Data
(60) Provisional application No. 63/647,803, filed on May 15, 2024.

(51) Int. Cl. G06F 9/24; G06F 3/04842; G06F 9/451

(52) U.S. Cl. CPC G06F 9/24; G06F 3/04842; G06F 9/451

(57) ABSTRACT

Systems, methods, and non-transitory computer readable media configured for launching a micro app associated with a user interface are provided. At least one processor may provide for display a user interface associated with a digital record. The processor may determine an age of the digital record and set a first flag responsive if the age of the digital record exceeds a first threshold and may set a second flag if a first parameter in the digital record is beneath a second threshold. An interactive element may persist until the at least one processor detects a user selection of the interactive element, or the processor determines that the age of the digital record exceeds a third threshold higher than the first threshold. If the age of the digital record exceeds a fourth threshold higher than the third threshold and the second flag remains set, the processor may terminate the digital record.

### CROSS-REFERENCE TO RELATED PATENT APPLICATION

This application claims the benefit of U.S. Provisional Patent Application No. 63/647,803, filed May 15, 2024, titled “Systems and Methods for Launching a Micro App Associated with a User Interface,” the entirety of which is incorporated by reference herein.

### TECHNICAL FIELD

The present disclosure relates generally to systems and methods for launching a micro application associated with a user interface. More specifically, but without limitation, this disclosure relates to providing users with options to manage a digital record.

### BACKGROUND INFORMATION

Financial service providers are rapidly expanding the use of mobile and web-based services and applications. Currently, most financial service providers provide web-based banking services, which allow users to perform basic functions and transactions remotely, for example, by using an application on a mobile device, such as a cell phone or a tablet having an online web interface or using the internet on a personal laptop computer. Mobile banking allows users to manage their money without visiting a physical brick and mortar branch bank location. Users may open new accounts, check account balances, pay bills, transfer funds, send money to others, deposit checks, receive user support, apply for loans, receive alerts, apply for credit cards, manage benefits, manage credit/debit cards, review transactions, and perform many other banking services on a mobile or web-based application on a mobile device or laptop, without travelling to a physical location.

Oftentimes, however, a user may open a new account, but leave it unfunded. Users may leave such accounts unfunded for a myriad of reasons, including that the user has forgotten that he or she opened the account. Eventually, these unfunded accounts may expire if they haven't been funded within a certain length of time, wherein the length of time may be set by the financial institution. Unfunded accounts are a widespread issue in the banking industry, and ensuring that these accounts are funded may help guarantee that financial institutions retain customers. Thus, there is a need to overcome these and other drawbacks of existing systems and for improved systems and methods for managing a digital record on the back end of a computer system, such that users may more efficiently manage their account on the front end.

Accordingly, some embodiments of this disclosure are directed to launching a micro app associated with a user interface, wherein the user interface is associated with a digital record. The digital record may contain information directed to a user's one or more bank accounts, including both savings and checking accounts, and/or a list of a user's prior transactions with one or more financial institutions. The user interface may present interactive elements to the user to update the digital record to prevent the user's account from being terminated.

### SUMMARY

One aspect of the present disclosure is directed to a system for launching a micro app associated with a user interface. The system may include at least one processor, and at least one memory configured to execute the instructions to perform operations. The operations may include associating a digital record with a unique identifier of a mobile device connected to a network; providing for display, on the mobile device, a user interface associated with the digital record; determining an age of the digital record; setting a first flag responsive to a determination that the age of the digital record exceeds a first threshold; setting a second flag responsive to a determination that a first parameter in the digital record is beneath a second threshold; responsive to the first flag and the second flag, displaying, on the user interface, an interactive element for launching a micro app associated with changing the first parameter, wherein the interactive element persists within the user interface until the at least one processor detects a user selection of the interactive element, and the second flag is cleared; or the at least one processor determines that the age of the digital record exceeds a third threshold higher than the first threshold; and responsive to a determination that the age of the digital record exceeds a fourth threshold higher than the third threshold and the second flag remains set, terminating the digital record.

Another aspect of the present disclosure is directed to a method for launching a micro app associated with a user interface. The method may perform operations including associating a digital record with a unique identifier of a mobile device connected to a network; providing for display, on the mobile device, a user interface associated with the digital record; determining an age of the digital record; setting a first flag responsive to a determination that the age of the digital record exceeds a first threshold; setting a second flag responsive to a determination that a first parameter in the digital record is beneath a second threshold; responsive to the first flag and the second flag, displaying, on the user interface, an interactive element for launching a micro app associated with changing the first parameter, wherein the interactive element persists within the user interface until the at least one processor detects a user selection of the interactive element, and the second flag is cleared; or the at least one processor determines that the age of the digital record exceeds a third threshold higher than the first threshold.

Yet another aspect of the present disclosure is directed to a non-transitory computer-readable medium. The non-transitory computer readable medium may perform a method for launching a micro app associated with a user interface. The method may perform operations including associating a digital record with a unique identifier of a mobile device connected to a network; providing for display, on the mobile device, a user interface associated with the digital record; determining an age of the digital record; setting a first flag responsive to a determination that the age of the digital record exceeds a first threshold; setting a second flag responsive to a determination that a first parameter in the digital record is beneath a second threshold; responsive to the first flag and the second flag, displaying, on the user interface, an interactive element for launching a micro app associated with changing the first parameter, wherein the interactive element persists within the user interface until the at least one processor detects a user selection of the interactive element, and the second flag is cleared; or the at least one processor determines that the age of the digital record exceeds a third threshold higher than the first threshold; and responsive to a determination that the age of the digital record exceeds a fourth threshold higher than the third threshold and the second flag remains set, terminating the digital record.

### BRIEF DESCRIPTION OF THE DRAWINGS

The accompanying drawings, which are incorporated in and constitute a part of this specification, illustrate disclosed embodiments and, together with the description, serve to explain the disclosed embodiments. In the drawings:

FIG. 1 illustrates an exemplary problem to be solved based on losing user accounts based on insufficient funds, consistent with disclosed embodiments.

FIG. 2 illustrates an exemplary solution to losing user accounts, consistent with disclosed embodiments.

FIG. 3 is a schematic illustration of the main components used for launching a micro app, consistent with disclosed embodiments.

FIG. 4 is an exemplary graphical user interface, consistent with disclosed embodiments.

FIG. 5 is a flowchart illustrating an exemplary method of launching a micro app associated with a user interface, consistent with disclosed embodiments.

FIG. 6 is a flowchart depicting an exemplary method for launching a micro app associated with a user interface, wherein the micro app is configured to change the first parameter based on information associated with a second digital record, consistent with disclosed embodiments.

FIG. 7 is a flowchart depicting an exemplary method for launching a micro app associated with a user interface, wherein the second digital record is associated with a third-party system, consistent with disclosed embodiments.

FIG. 8 is a flowchart depicting an exemplary method for launching a micro app, wherein the at least one processor is further configured to determine a current location of the mobile device and display locations of one or more automated kiosks, consistent with disclosed embodiments.

FIG. 9 is a flowchart depicting an exemplary method for launching a micro app, wherein the micro app is configured to change the first parameter based on information received from a second mobile device, consistent with disclosed embodiments.

FIG. 10 is a flowchart depicting an exemplary method for a user to access their digital record information, consistent with disclosed embodiments.

FIG. 11 is a flowchart depicting an exemplary method for a user to review options for changing a first parameter associated with the digital record, consistent with disclosed embodiments.

### DETAILED DESCRIPTION

In the following detailed description, numerous specific details are set forth in order to provide a thorough understanding of the disclosed exemplary embodiments. However, it will be understood by those skilled in the art that the principles of the example embodiments may be practiced without every specific detail. Well-known methods, procedures, and components have not been described in detail so as not to obscure the principles of the example embodiments. Unless explicitly stated, the example methods and processes described herein are not constrained to a particular order or sequence or constrained to a particular system configuration. Additionally, some of the described embodiments or elements thereof can occur or be performed simultaneously, at the same point in time, or concurrently. Reference will now be made in detail to the disclosed embodiments, examples of which are illustrated in the accompanying drawings.

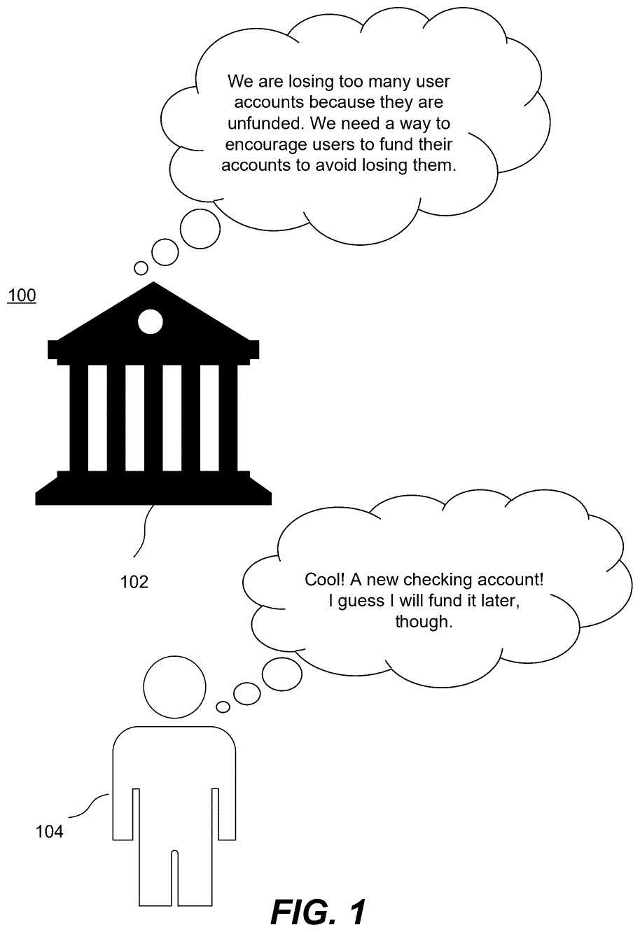

By way of example, FIG. 1 illustrates an exemplary problem to be solved based on losing user accounts based on insufficient funds, consistent with disclosed embodiments. In this example, financial institution 102 may provide services to one or more users 104. In a non-limiting example, these services may include personal banking, commercial banking, investment banking, mortgage, and/or auto loan services. Financial institution 102 may require a user 104 to create an account for the user to have access to the one or more services. In a non-limiting example, the account may be a checking account or a savings account. However, a user 104 may open a new checking account, but may leave it unfunded for a myriad of reasons. In a non-limiting example, the user may leave their new account unfunded because they primarily use another financial institution for banking, they do not have funds to fund the new account, and/or the user simply forgets to fund the account. Over time, not funding accounts leads to financial institution 102 losing users' accounts. Financial institutions may close users' inactive accounts to minimize liability pertaining to those accounts, such as negative account balances or fraud. Additionally, it is not profitable for a financial institution to maintain unfunded accounts.

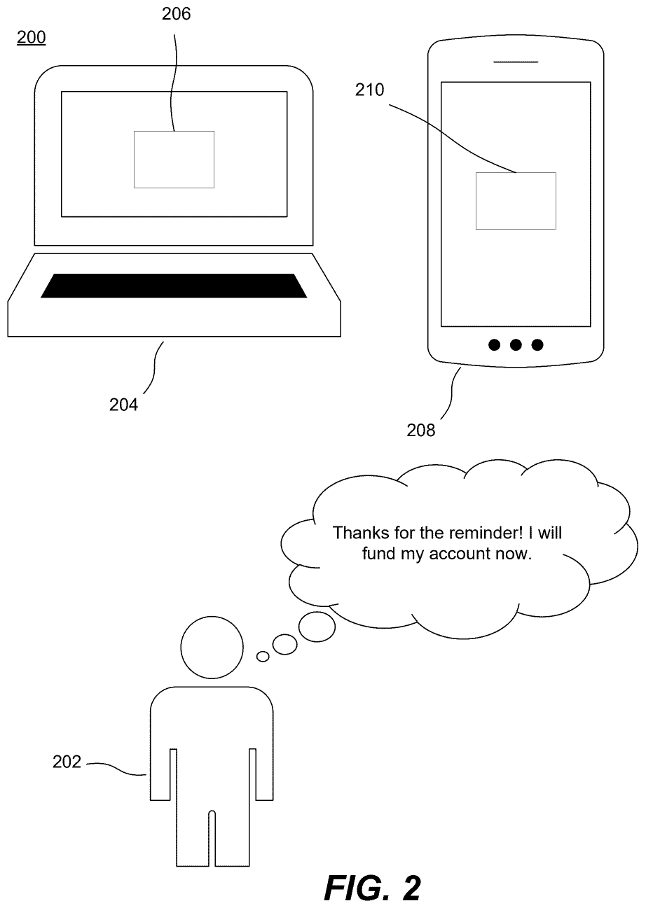

By way of example, FIG. 2 illustrates an exemplary solution to losing user accounts, consistent with disclosed embodiments. In this example, a user 202's computing device 204 may display interactive web element 206. As used herein, the term “display” refers to any physical device capable of providing a visual presentation of data. Examples of physical devices acting as displays include computer screens, smartphone screens, tablet screens, smartwatch screens, laptop screens, video walls, projectors, head-mounted displays or virtual/extended reality headsets. Additionally, displays may utilize graphical user interfaces (GUIs) to permit user interaction with data. In many GUIs, a visual presentation of data is often provided using a graphical user interface component known as a window, or a page. In this context a common display refers to the situation wherein groupings are presented on a single widow or page. Any visual presentation of a device or display may be characterized by dimensions. Consistent with disclosed embodiments, interactive web element 206 may launch a micro app associated with funding a user 202's account. In another example, a user 202's smart phone 208 may display interactive mobile element 210. Consistent with disclosed embodiments, interactive mobile element 210 may also launch a micro app associated with funding the user 202's account.

Disclosed embodiments may involve systems, methods, and non-transitory computer readable media configured to launch a micro app. The computer readable storage medium may be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present disclosure may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present disclosure.

Aspects of the present disclosure described herein with reference to flowchart illustrations and/or block diagrams of methods, apparatus (systems), and computer program products according to embodiments of the disclosure. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general-purpose computer, special purpose computer, or other programmable data processing apparatus to produce a machine, such that the instructions, which execute via the at least one processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

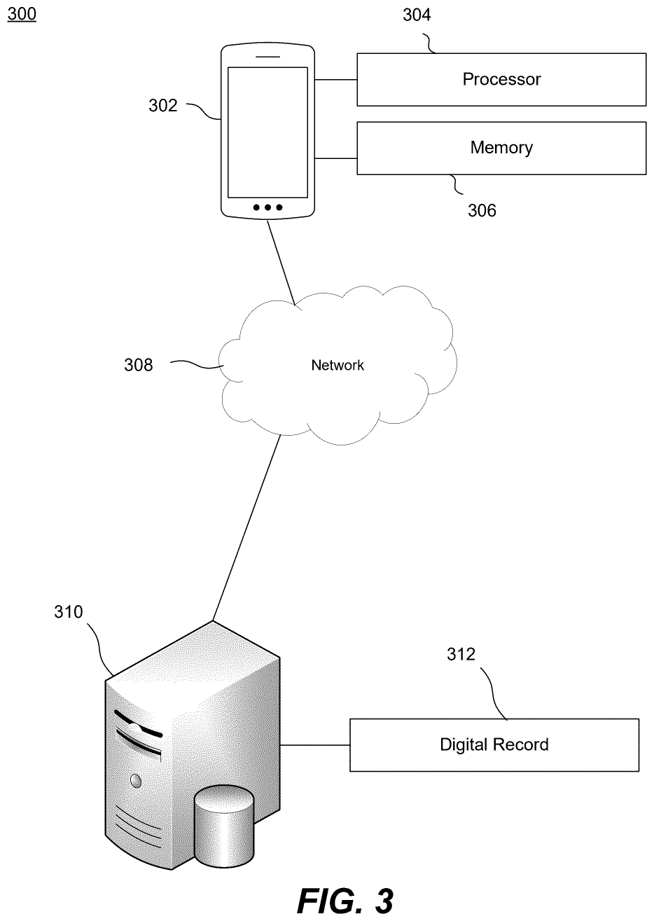

By way of example, FIG. 3 is a schematic illustration of the main components required for launching the micro app, consistent with disclosed embodiments. Mobile device 302 may contain at least one processor 304 and a memory 306. Mobile device 302 may be connected to network 308 and may contain a unique identifier. Mobile device 302 may communicate with server 310 via network 308, wherein server 310 stores the digital record 312. Server 310 may also contain a memory, similar to, for example, memory 306. Alternatively, digital record 312 may be stored in memory (such as, for example, memory 306) associated with mobile device 302. Consistent with disclosed embodiments, processor 304 may associate the digital record 312 with mobile device 302, based on mobile device 302's unique identifier.

The system may include one or more user devices (such as, for example, mobile device 302). Mobile device 302 may be one or more of a desktop computer, a laptop, a tablet, a smartphone, a multifunctional watch, a pair of multifunctional glasses, a tracking device, or any suitable device with computing capability. Mobile device 302 may have an online banking or financial account management application installed thereon, which may enable a user to communicate with, for example, with an institution and/or third-party service provider via network and/or a local network. In one example, the institution may be a financial institution. An account may refer to a bank account, such as a checking or savings account. Additionally, mobile device 302 may connect to the financial institution and/or third-party service provider through use of web browser software via the network and/or a local network (such as, for example network 308 as described and exemplified elsewhere in this disclosure).

Launching refers to starting, beginning, or instituting one or more computer programs. In one example, the computer program may be a micro app. A micro app, or micro application, refers to a specialized application designed to perform one task or use case with the only objective of doing it well. Consistent with disclosed embodiments, the micro app may execute stored instructions to change a first parameter in a digital record. Changing the first parameter in digital record 312 may then cause the at least one processor (such as, for example, processor 304) to remove an interactive element from a graphical user interface, as described elsewhere in this disclosure. In another example, the micro app may be directed to transferring money between a user's accounts.

In some embodiments, and referring the FIG. 3, the system may comprise at least one processor (such as, for example, processor 304) configured to execute instructions. The at least one processor may include any physical device or group of devices having circuitry configured to perform one or more logic operations on an input or inputs. For example, the at least one processor may include one or more integrated circuits (IC), including application-specific integrated circuit (ASIC), microchips, microcontrollers, microprocessors, all or part of a central processing unit (CPU), graphics processing unit (GPU), digital signal processor (DSP), field-programmable gate array (FPGA), or other circuits suitable for executing instructions or performing logic operations. The at least one processor may take the form of, but is not limited to, a microprocessor, embedded processor, or the like, or may be integrated in a system on a chip (SoC). Furthermore, according to some embodiments, the processor may include one or more of the family of processors manufactured by Intel®, AMD®, Qualcomm®, Apple®, NVIDIA®, or the like. The at least one processor may also be based on the ARM architecture, a mobile processor, or a graphics processing unit, etc. The disclosed embodiments are not limited to any type of processor configured in the server.

In some embodiments, the system may comprise a memory storing instructions, such as, for example, memory 306. In some examples, the user device may comprise a memory, a processor (such, for example, processor 304), and/or other specialized hardware that is configured to execute one or more methods of the disclosed embodiments. The memory may include one or more storage devices configured to store instructions used by the at least one processor to perform functions related to a server. The disclosed embodiments are not limited to particular software programs or devices configured to perform dedicated tasks. For example, the memory may store a single program, such as a user-level application, that performs the functions associated with the disclosed embodiments, or may comprise multiple software programs. Additionally, the at least one processor (such as, for example, processor 304) may, in some embodiments, execute one or more programs (or portions thereof) remotely located from one or more servers. Furthermore, the memory (such as, for example, memory 306) may include one or more storage devices configured to store data for use by the programs. The memory may include, but is not limited to, a Random Access Memory (RAM), a Read-Only Memory (ROM), a hard drive, a solid state drive, an optical disk, other permanent, fixed, or volatile memory, a CD-ROM drive, a peripheral storage device (e.g., an external hard drive, a USB drive, etc.), a network drive, a cloud storage device, or any other mechanism capable of storing instructions. In some embodiments, the at least one processor may include more than one processor. Each processor may have a similar construction or the processors may be of differing constructions that are electrically connected or disconnected from each other. For example, the processors may be separate circuits or integrated in a single circuit. When more than one processor is used, the processors may be configured to operate independently or collaboratively, and may be co-located or located remotely from each other. The processors may be coupled electrically, magnetically, optically, or by any other way that permits them to interact with each other. In one example, the memory may store information relevant to launching the micro app, such as the user's checking account number, the account's routing number, the amount of funds in the user's account, and/or the age of the account. The at least one processor may be configured to retrieve this information in response to receiving a command from a user.

Communications may take place across various types of networks (such as, for example, network 308), such as the Internet, a wired Wide Area Network (WAN), a wired Local Area Network (LAN), a wireless WAN (e.g., WiMAX), a wireless LAN (e.g., IEEE 802.11, etc.), a mesh network, a mobile/cellular network, an enterprise or private data network, a storage area network, a virtual private network using a public network, a nearfield communications technique (e.g., Bluetooth, infrared, etc.), or various other types of network communications. In some embodiments, the communications may take place across two or more of these forms of networks and protocols. It is understood that in some embodiments, one or more aspects of the disclosed systems and methods may also be used in a localized system, with one or more of the components communicating directly with each other.

In some embodiments, the memory may include a database. The database may be coupled to a server (such as, for example, server 310). The database may be included on a volatile or non-volatile, magnetic, semiconductor, tape, optical, removable, non-removable, or other type of storage device or tangible or non-transitory computer-readable medium. The database may also be part of the server or separate from the server. When the database is not part of the server, the server may exchange data with the database via a communication link. The database may include one or more memory devices that store data and instructions used to perform one or more features of the disclosed embodiments. The database may include any suitable databases, ranging from small databases hosted on a workstation to large databases distributed among data centers. The database may also include any combination of one or more databases controlled by memory controller devices (e.g., server(s), etc.) or software. For example, the database may include document management systems, Microsoft SQL™ databases, SharePoint™ databases, Oracle™ databases, Sybase™ databases, other relational databases, or non-relational databases, such as mongo and others. In some embodiments, the server may include one or more input/output devices, communications devices, displays, and/or other interfaces (e.g., server-to-server, database to-to-database, or other network connections). The database may store account information, audit information, transaction information, asset identifier information, asset type information, user information, user history information, transaction history information, and other data.

In some embodiments, the at least one processor (such as, for example, processor 304) may be configured to associate a digital record with a unique identifier of a mobile device connected to a network. A digital record (such as, for example, digital record 312) may refer to information or an account that is associated with a particular user. The digital record may include information directed to the user's one or more bank accounts, including both savings and checking accounts, and/or a list of a user's prior transactions with one more financial institutions, such as a bank. A user's digital record may be stored in a memory associated with the user's mobile device, a physical remote server, and/or a cloud server. The at least one processor may be configured to access the user's digital record to perform a plurality of tasks and may be configured to perform these tasks automatically or based on user input. A described herein, these tasks may include determining an age of digital record 312 and changing one or more parameters associated with digital record 312, such as the quantity of funds present in the user's account. Any changes that the user makes to their account may be logged in the digital record 312, consistent with disclosed embodiments. As used herein, logged in the digital record refers to the at least one processor storing any user changes in the memory associated with the digital record. For example, the at least one processor may update the digital record to reflect that the user has deposited or withdrawn funds from their account.

A unique identifier may refer to a numeric or alphanumeric string that identifies a single entity in a system. A mobile device (such as, for example, mobile device 302) may refer to a portable device that can receive and transmit information. Here, the unique identifier of the mobile device may refer to the mobile device's IP address, serial number, and/or barcode. In one example, a server may store the digital records of multiple users. In this example, the unique identifier may be the device's serial number. In one example, processor 304 may associate a digital record 312 with a unique identifier of a mobile device 302 by analyzing the serial number of the mobile device 302, comparing the serial number of the mobile device with serial number information stored on the server (such as, for example, server 310), and identifying and separating the user's digital record from the remainder of the digital records stored on the server based on the serial number of the mobile device 302. In another example, the processor may identify the user's digital record based on the IP address of a user's mobile device 302. The processor may store the device's unique identifier information on the server, such that the digital record is associated with the user's mobile device the next time the user wishes to access their digital record.

Consistent with disclosed embodiments, processor 304 may determine an age of digital record 312 by analyzing metadata associated with the user's account, such as the timestamp of when the user created their account. The age of the digital record 312 may refer to how long the digital record 312 has been active. In one example, the age of the digital record 312 may refer to how long a user's checking account has been open. In this example, the age of the digital record 312 may be 0, 30, 60, or 90 days. In another example, the age of the digital record 312 may refer to how long a user's savings account has been open. In this example, the digital record 312 is associated with user's primary financial institution, wherein the user's primary financial institution may refer to the user's bank.

The processor may determine the age of digital record 312 based on metadata associated with the user's account. Bank account metadata may include, for example, the user's account number, routing number, and the timestamp associated with when the user created the account associated with digital record 312. Processor 304 may be configured to compare the timestamp when the user created their account with the current date, thereby determining the age of the digital record. In this example, processor 304 may analyze the timestamp associated with the date the user created the account associated with digital record 312, compare it with the current date, and determine that digital record 312 has been active for 45 days.

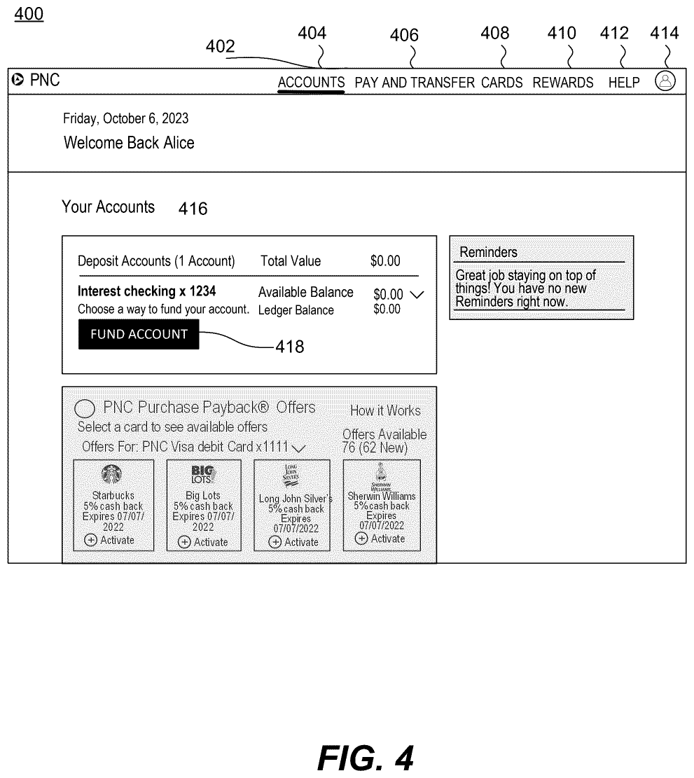

By way of example, FIG. 4 is an exemplary user interface, consistent with disclosed embodiments. References to components discussed with respect to FIG. 3 are incorporated herein. GUI 400 may permit one or more users to interact with electronic devices or software through graphical icons, visual indicators, on-screen elements such as windows, buttons, menus, and dialog boxes, and/or text-based commands. In a non-limiting example, the user may touch, press, or otherwise interact with an icon on the user interface. A user may access GUI 400, via a user's mobile device (such as a smart phone) or a laptop computer. In this example, GUI 400 may be displayed on a webpage, which a user may access using a computer.

Consistent with disclosed embodiments, GUI 400 may contain various menus in menu bar 402, which allows a user to manage their digital record activity, such as account activity associated with a financial institution, subscription service, and/or SaaS platform. The at least one processor may be configured to update the digital record based on the user's activity. Menu bar 402 may include an accounts menu 404, wherein the user may access multiple accounts (which may correspond to various digital records, as described and exemplified elsewhere in this disclosure), such as a checking and/or a savings account, via accounts menu 404. The at least one processor may be configured to record any changes in digital record by storing the changes in the memory associated with digital record. The processor may provide for display on the GUI 400 associated with mobile device 302 the age of the digital record 312

FIG. 4 shows GUI 400 open to accounts menu 404. Menu bar 402 may also contain pay and transfer pull-down menu 406. Pay and transfer pull-down menu 406 may provide the user with options to pay upcoming bills and to transfer money from, consistent with disclosed embodiments, a second digital record. The second digital record may be internal to the financial institution or may be associated with a third-party financial institution, a second mobile device, and/or a Near Field Communication (NFC) payment platform, as described and exemplified elsewhere in this disclosure. Menu bar 402 may also contain cards menu 408. Cards menu 408 may present options for users to access one or more bank, debit, or credit cards associated with the user's account. Cards menu 408 may present the user with options to pay down one or more of the user's credit cards. Each of these options may be an interactive element. Rewards menu 410 may present the user with options to exchange credit part points for travel or dining rewards. Help menu 412 may link the user to the institution's user service help desk. User menu 414 may provide the user with options to change the account settings, including updating the user's address, income, username, password, and/or other identifiable characteristics. Consistent with disclosed embodiments, each element 404 to 414 may be a selectable icon, wherein a change to GUI 400 occurs upon receiving user input. For example, the processor may provide for display, upon receiving user input on element 404, provide for display a pop-up window, a modal window, and/or may take the user to a second GUI.

Referring to FIG. 4, accounts menu 404 may display a user's digital record on account home page 416. A user may have one or more accounts, such as a checking or savings account. Each checking or savings account may correspond to a separate digital record. The at least one processor may retrieve information, such as the length of time associated with the digital record on the back end of the mobile application, i.e., the data access layer of a program or application, whereas the at least one processor may be configured to display the user's checking account information on the front end-GUI 400. A data access layer may refer to a software architectural component that acts as an intermediary between an application's business logic and the underlying data storage system. Account home page 416 may display one or more parameters associated with the digital record, such as the value of the digital record and the age of the digital record.

At least one processor may perform a task in response to the first flag and/or the second flag, such as displaying interactive element 418 on account home page 416. An interactive element may refer to any component or feature within a system, interface (such as a GUI), or environment that allows one or more users to actively engage with and/or manipulate content or functionality. Non-limiting examples of interactive elements may include a tile, button, and/or toggle. Interactive element 418 may be square, rectangular, triangular, circular, trapezoidal, or otherwise polygonal in shape. The interactive element (such as, for example, interactive element 418) may also be shaded, filled with one or more colors, or otherwise stand out to the user on GUI 400. In one example, interactive element 418 may be a button, which the user may push, touch, select, or otherwise interact with. Interactive element 418 may also contain the words “fund account.” The “fund account” lettering may be white, gray, black, or any other color that may stand out to the user.

Consistent with disclosed embodiments, interactive element 418 may, via the at least one processor, launch a micro app associated with changing the first parameter. The processor may launch the micro app in response to user input. Changing the first parameter may refer to the user adding funds to their account. In this example, changing the first parameter may update the digital record such that the first parameter is no longer beneath the second threshold. Updating the digital record may involve the processor executing instructions to change a numerical value associated with the first parameter, i.e., the amount of funds a user has in their account. The processor may automatically update the numerical value associated with the first parameter based on the newly deposited funds in the user's account. The processor may retrieve information associated with the first parameter, i.e., the user's account balance, and update the first parameter in the digital record.

Referring to FIG. 4, selecting interactive element 418 may cause the processor to prompt the user to change the first parameter based on information associated with a second digital record. The second digital record may be associated with the user's primary financial institution. The processor may be configured to prompt the user to change the first parameter display, on the user interface, an interactive element for launching a micro app associated with changing the first parameter, as described and exemplified elsewhere in this disclosure.

In another example, selecting interactive element 418 may prompt the user to change the first parameter based on information associated with a second digital record, wherein the second digital record is associated with a third-party system, such as a user's brokerage or investment account. In yet another example, selecting interactive element 418 may prompt the at least one processor to determine the user's current location, and display, on GUI 400, one or more locations of one or more automated kiosks within a predetermined proximity of the current location. In one example, the one or more automated kiosks may be an automated teller machine (ATM) and/or another self-service kiosk associated with financial institution.

In another example, the at least one processor may be configured to execute the instructions to display, on GUI 400 options to fund the account by depositing at least one check. In one example, the user may deposit a check via mobile remote deposit. In another example, the at least one processor may direct a user to deposit a check via an ATM. In yet another example, the at least one processor may direct a user to deposit a check via mail. The user may review the check deposit options via account home page 416, and may select check deposit options via one or more selectable elements. Depositing a check via any of these methods may the cause processor to execute instructions to change the first parameter in the digital record 312, thereby clearing the second flag and removing interactive element 418 from GUI 400.

Referring to FIG. 4, interactive element 418 may persist on account home page 416 until the processor detects that a user selects the interactive element 418. A user may click, press, or otherwise interact with interactive element 418. Clearing the second flag may also remove interactive element 418 from GUI 400. The other elements on GUI 400 (i.e., elements 402 to 414) may remain on GUI 400, while interactive element 418 disappears from GUI 400. Consistent with disclosed embodiments, the processor may be configured to execute stored instructions to remove interactive element 418 from GUI 400 such that interactive element 418 is no longer visible and/or accessible to the user on account home page 416.

As described herein, interactive element 418 may stand out from other elements 404-414 such that the user prioritizes funding the account associated with the digital record. Clearing the second flag such that interactive element 418 is removed from GUI 400 may nudge the user to fund his or her account so that the user may focus on addressing other account options such as elements 404 to 416.

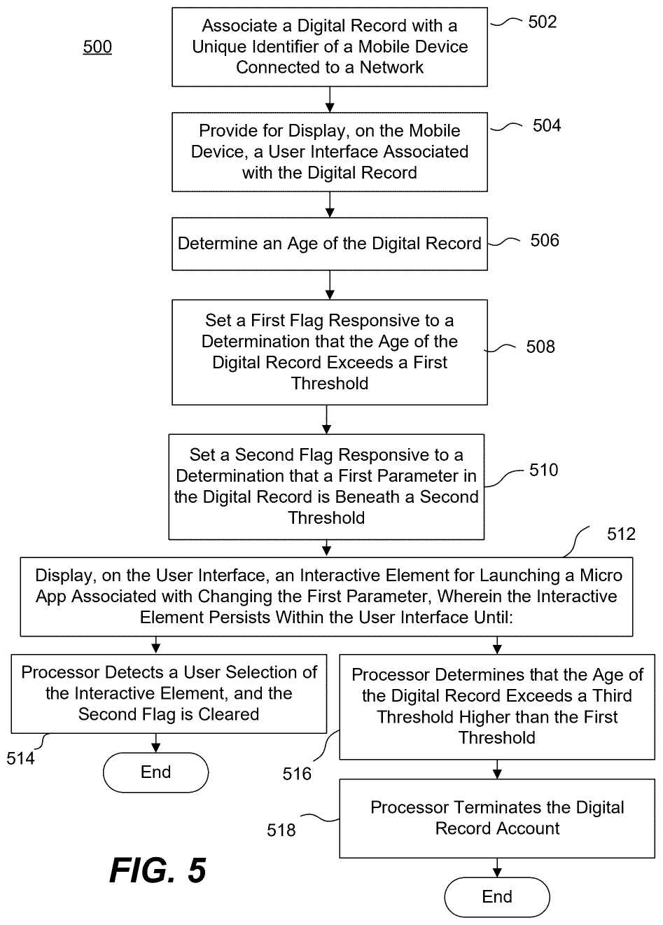

By way of example, FIG. 5 is a flowchart illustrating an exemplary method 500 of launching a micro app associated with a user interface, consistent with disclosed embodiments. References to components discussed with respect to FIG. 3 are incorporated herein. References to GUI elements discussed with respect to FIG. 4 are also incorporated herein. At step 502, the at least one processor may associate a digital record with a unique identifier of mobile device connected to a network. Consistent with disclosed embodiments, the processor may associate the digital record with a unique identifier of mobile device by storing the unique identifier's alphanumeric serial information on a server, such that processor may retrieve information related to the digital record at a later time. The processor may recognize the mobile device based on its unique identifier, and may retrieve information stored on the digital record using look up tables, artificial intelligence, a search algorithm such as a linear search, binary search, interpolation search, and/or jump search, and/or a retrieval algorithm such as a predictive retrieval algorithm. A processor may retrieve data other than the digital record in a similar manner, i.e., using similar methods or algorithms.

At step 504, the at least one processor may be configured to provide for display, on the mobile device, a user interface associated with the digital record. The user may see their account information on the front end of the system, whereas the digital record may be stored in the back end of the system, for example, via a server. Any changes the user makes to their account on the front end, i.e., what a user sees and where the visual elements are located, may be reflected in the digital record in the back end of the system, wherein the back end refers to the data infrastructure that makes the application work. In this example, the at least one processor provides for display the user's account information, which may be stored on the user's digital record. As described herein, the at least one processor may be configured to retrieve information associated with the user's digital record using, in a non-limiting example, lookup tables and/or cache prefetching. Consistent with disclosed embodiments, the digital record may be stored on a server.

The financial institution where the user performs the majority of their banking tasks may be referred to as the user's primary institution or primary system. In other words, the primary institution may refer to the system where the user typically deposits checks, from gifts, paychecks, or otherwise. The user interface may be accessible via a web browser and/or a mobile application. The user interface may contain a variety of options for managing a user's account, including funding the account, closing the account, opening a new account, and/or contacting customer service. The user may select these options via a plurality of interactive elements. Each option for managing a user's account may change one or more parameters in the digital record. Examples of one or more parameters may include an alphanumerical value associated with the user's account balance and/or how long a user's account has been open. For example, a user depositing funds into their account may change one parameter in the digital record, and a user withdrawing funds may change that same parameter in the digital record. In this example, in response to a user depositing funds, the processor may be configured to automatically update an alphanumeric value in the digital record corresponding to the user's account balance.

In some embodiments, and referring to FIG. 5, the at least one processor may be configured to determine an age of the digital record at step 506. Determining may refer to a processor making a decision based on presently available information. The at least one processor may be configured to set a first flag responsive to a determination that the age of the digital record exceeds a first threshold at step 508. Setting may refer to positioning, situating, or otherwise implementing something at a specified place or value. Setting a first flag may refer to using one or more bits to store a binary value or a Boolean variable for signaling certain code conditions. The first flag may be based on whether the age of the digital record exceeds a certain value. Here, the processor may use one or more bits to store in memory that the age of digital record may exceed a certain value, i.e., the first threshold. In this example, the flag may be a binary flag, indicating “yes” or “no.” Here, if the processor determines that the age of the digital record exceeds a first threshold, it will set a “yes” flag. The processor may automatically determine the age of digital record each time the user attempts to access their account.

A first threshold may refer to the length of time that has passed before something happens. Here, a first threshold may refer to the length of time that passes before the at least one processor terminates a user's account, and/or an interactive element disappears from the user interface. In this example, the first threshold may be set automatically based on the user's transaction history, by the financial institution, or set by the user. In each example, the processor may be configured to store a numeric value in memory corresponding to the length of time a user's account has been open. In a non-limiting example, the first threshold may be 0, 30, 45, 60, 90, 180, or 365 days, or any other length of time between 0 and 365 days. Accordingly, the processor may be configured to store any numerical value between 0 and 365, i.e., the first threshold, in memory, wherein the processor is configured to set a flag when processor determines that the age of the account exceeds the first threshold. The processor may determine the age of digital record consistent with the methods described herein, i.e., by comparing the timestamp of when the user created their account with the current date.

In one example, the processor may set a first threshold at 0 days. In another example, the processor may set a first threshold at 45 days. The processor may store the flag information in memory. The processor may also store the first flag information on the digital record associated with the server. In each example, the processor is configured to use one or more bits to store a binary “yes” or “no” value to signal whether the age of the digital record exceeds the first threshold.

In some embodiments, and referring to FIG. 5, the at least one processor may be configured to set a second flag responsive to a determination that a first parameter in the digital record is beneath a second threshold at step 510. In one example, the first flag may be directed to the length of time a user's account has been open, whereas the second flag may be directed to whether the digital record reflects that the user's account contains any funds. The processor may retrieve and analyze information associated with the digital record, such as an alphanumerical value, to determine whether the user's account contains any funds. In this example, the second flag may also be a binary value, and the second threshold may also be a numerical value. The processor may set the second flag in the same or similar manner as the first flag. A first parameter may be a numerical value, and may refer to a quantity of user's funds, i.e., the first parameter may refer to how much money a user possesses in their account. The processor may store the numerical value associated with the first parameter in memory.

A second threshold may refer to a numerical value stored in memory, corresponding to the exact amount of the user's funds, as reflected in the digital record, wherein the user is required to keep a certain amount of funds in their account to keep the digital record. The second threshold may be set by the financial institution, wherein the processor is configured to store a numerical value associated with the user's account balance in a memory associated with the digital record. In one example, the second threshold may be, 1, 5, 10, 20, 50, or 100, corresponding to one dollar, 5 dollars, 10 dollars, 20 dollars, 50 dollars, or 100 dollars. Here, the processor may set a second flag if the at least one processor determines that the first parameter is below a second threshold. In this example, the second threshold may be one dollar. Here, the processor may set a second flag if the digital record reflects that a user has less than a dollar in their account.

In one example, a processor may set the second threshold at five dollars, i.e., a numerical value of 5. The processor may store the numerical value associated with the second threshold on the digital record associated with the server, or alternatively, a memory associated with the mobile device. The processor may set the second flag if, after communicating with the server and digital record via the network, the processor determines that the first parameter is below the second threshold of five dollars. The processor may determine that the first parameter in the digital record is beneath the second threshold by comparing the first parameter value to the second threshold value. The processor may use one or more bits to store a binary value, i.e., the second flag, signaling that the first parameter is below the second threshold.

In some embodiments, and referring to FIG. 5, responsive to the first flag and the second flag, the at least one processor may execute instructions to display, on the user interface, an interactive element for launching a micro app associated with changing the first parameter, at step 512. The processor may be configured to periodically analyze the digital record to determine whether the first flag and/or the second flag are present. The processor may determine whether the first flag and/or the second flag are present by analyzing information associated with the digital record, such as, for example, the timestamp associated with digital record corresponding to when digital record was created, and the numerical value associated with the first parameter. In one example, the processor may be configured to analyze whether the first flag and/or the second flag is present each time the user logs into their account. In another example, the processor may be configured to analyze whether first flag and/or second flag is present every hour and/or every day.

In some embodiments, and referring to FIG. 5, the interactive element may persist within the GUI until the at least one processor detects a user selection of the interactive element, and the second flag is cleared at step 514. Persist may refer to continuing to exist. As used herein, persisting may refer to the interactive element continuing to be selectable by the user until the second flag is cleared or removed. The processor may detect a user selection by reading instructions from memory and analyzing them to determine what operation to perform, here, funding a user's account. The processor may clear the second flag if it detects that the first parameter is above the second threshold. Clearing the second flag may involve changing the binary value associated with the second flag. For example, the processor may clear the second flag by changing binary value from “yes” to “no.”

In one example, the user may select the interactive element and may add funds to their account. The processor may detect that the user added funds to their account, and may update, in response to such detection, the numerical value associated with the first parameter in the digital record. In this example, the user may add five dollars to their account. The processor therefore increases the numerical value associated with the first parameter in the digital record from 0 to 5. In this example, the second threshold may be one dollar, represented numerically on the digital record as “1.” Thus, adding five dollars to the user's account updates the digital record such that the first parameter is no longer beneath the second threshold—one dollar—thereby clearing the second flag. The processor clears the second flag by executing instructions to change the binary value associated with the second flag from “yes” to “no,” as the first parameter in the digital record is no longer beneath the second threshold. Clearing the second flag ensures that the user's account is still active because the user's account contains funds. Accordingly, the financial institution does not unnecessarily lose the user's account because the user's account is now active and funded, rather than sitting inactive and unfunded. In this example, if the user spends the five dollars, the first parameter associated with the digital record may decrease from 5 to 0, which may trigger the processor to set a second flag.

The processor may clear the second flag by executing instructions to change the binary value associated with the second flag from “yes” to “no,” as the first parameter in the digital record is no longer beneath the second threshold. In this example, changing the first parameter may involve adding funds to the user's account, here, five dollars, thus raising the first parameter in the digital record above the second threshold. In an example where the second threshold is five dollars and the first parameter is zero dollars, a processor may detect the increase in funds and execute instructions to increase the numerical value associated with the first parameter from 0 to 5.

In some embodiments, and referring to FIG. 5, the interactive element 418 may persist within the GUI until the at least one processor determines that the age of the digital record exceeds a third threshold higher than the first threshold at step 516. The processor may determine the age of the digital record as described elsewhere in this disclosure. The first threshold and the third threshold may measure the same parameter, i.e., the age of digital record. For example, the first and third threshold may both measure the length of time digital record has been active. In one example, the first threshold may be 0 days, and the third threshold may be 90 days. The interactive element may disappear from the GUI after 90 days. In this example, the processor is configured to detect whether the age of the digital record exceeds the third threshold. Here, the processor is configured to periodically compare the current date with the date the user created the account associated with the digital record, wherein the processor determines the digital record creation date by analyzing metadata, such as the creation timestamp associated with digital record. The processor may be configured to compare the current date with the digital record creation date continuously, every hour, every four hours, every eight hours, and/or every day. The processor may be configured to compare the current date with the digital record creation date based on user and/or financial institution preference. In this example, the processor may be configured to remove the interactive element from the GUI 400 if the processor determines that the age of the digital record exceeds a third threshold.

In some embodiments, the third threshold may be set by the financial institution. For example, the financial institution may set the first threshold at 30 days and the third threshold at 180 days, wherein the processor is configured to remove interactive element 418 from user interface after 180 days.

In one example, the processor may determine that the digital record has been active for 87 days, wherein the first threshold is 7 days and the third threshold is 90 days. Consistent with this disclosure, the processor may determine the age of the digital record by comparing the current date to the digital record's creation date, where the processor is configured to extract the digital record's creation date based on metadata, such as a timestamp, associated with the digital record. The interactive element may persist on the GUI until the processor determines that the age of digital record is longer than 90 days, where the processor is configured to execute instructions to remove the interactive element from the GUI.

In some embodiments, and referring to FIG. 5, responsive to a determination that the age of the digital record exceeds a fourth threshold higher than the third threshold and the second flag remains set, the at least one processor is configured to terminate the digital record at step 518.

The fourth threshold may refer to a length of time, wherein the fourth threshold may be higher than each of the first threshold and the third threshold. The first threshold, the third threshold, and the fourth threshold may measure the same parameter, here, the age of digital record. The fourth threshold may be the point at which the at least one processor terminates the digital record. The processor may be configured to automatically determine whether the second flag is set when the age of the digital record exceeds the fourth threshold. The processor may be configured to retrieve the second flag data from memory. The processor may terminate the digital record by removing digital record from a memory associated with the remote server, or alternatively, memory associated with the mobile device. Terminating the digital record may clear data from the cache associated with the memory, which may allow the processor to efficiently handle new tasks and data, such as storing a new digital record.

In one example, the first threshold may be 0 days, the third threshold may be 90 days, and the fourth threshold may be 180 days. Here, the processor may be configured to terminate the digital record after the age of digital record surpasses the fourth threshold and the second flag remains set, i.e., the processor determines that the first parameter remains below the second threshold and the binary value associated with the second flag has not changed. The processor may be configured to determine the age of the digital record in a manner consistent with this disclosure. Here, the processor may be configured to terminate the digital record after 180 days passes, and the first parameter is unchanged, i.e., the user has not funded their account.

In another example, the processor may be configured to determine that the digital record has been active for 157 days. In this example, the first threshold is 7 days, the third threshold is 90 days, and the fourth threshold is 180 days. The interactive element may persist on the GUI until the processor determines that the age of digital record is longer than 90 days. In this example, the processor is configured to remove the interactive element from the GUI after 90 days. However, the user's account and digital record remain active, provided that processor does not determine that the age of the digital record exceeds the fourth threshold. In this example, after 180 days passes, the processor may be configured to terminate the digital record. The processor may terminate digital record by removing it from memory.

In another example, the interactive element may persist within the GUI until the user exits the GUI. In this example, the user may exit the GUI by selecting the back button in the user's internet browser. In another example, the user may exit the GUI 400 by closing the mobile app on the user's mobile device.

In some embodiments, the fourth threshold and the third threshold have the same value, the value referring to the numerical amount associated with each of the third and fourth threshold. For example, the third threshold and the fourth threshold may each be 90 days. The processor may store this information in a memory associated with the server. The server (which may be a remote server or a cloud server) may be associated with the digital record. In this example, the processor may be configured to both remove the interactive element from the user interface and terminate the digital record after 90 days. In another example, the fourth threshold and the third threshold may each be 180 days. Accordingly, the processor may be configured to both remove the interactive element from the GUI and terminate the digital record after 180 days. As described and exemplified elsewhere in this disclosure, terminating the digital record may free up memory to perform other operations, such as managing a plurality of digital records, more quickly and efficiently.

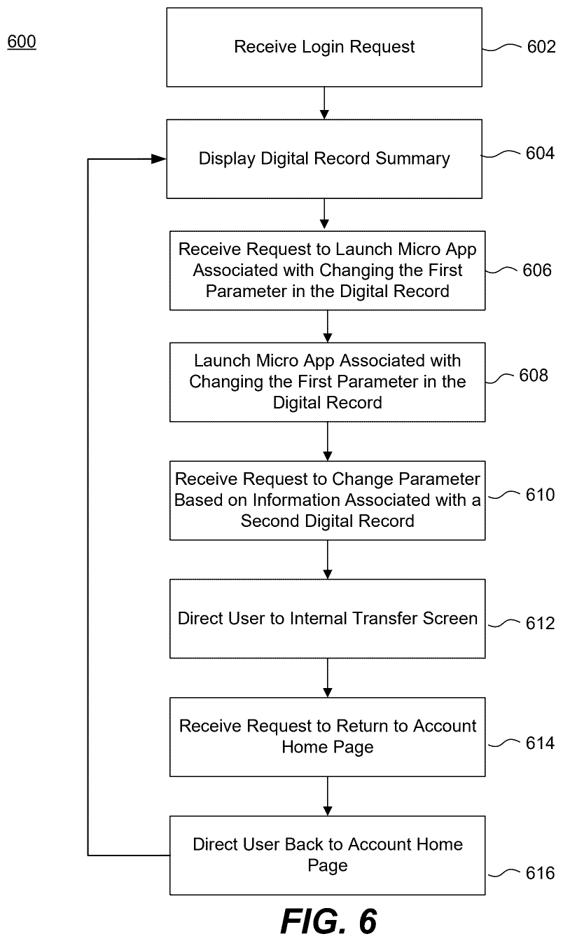

By way of example, FIG. 6 is a flowchart depicting an exemplary method 600 for launching a micro app associated with a user interface, wherein the micro app is configured to change the first parameter based on information associated with the second digital record, consistent with disclosed embodiments. References to components discussed with respect to FIG. 3 are incorporated herein. References to GUI elements discussed with respect to FIG. 4 are also incorporated herein. At step 602, the at least one processor may receive a login request from a user. The login request may consist of the user correctly entering their username and password, or otherwise meeting authentication requirements specified by the financial institution. At step 604, the graphical user interface may display a summary of the user's digital record. As described in reference to FIG. 4, the digital record summary may list the user's deposit accounts, such as a checking account and/or savings account. The at least one processor may retrieve this information from memory and present it to the user on the GUI.

At step 606, the at least one processor may receive a request to launch a micro app. Consistent with disclosed embodiments, the micro app may be associated with changing the first parameter, wherein changing the first parameter may involve adding funds to the user's one or more accounts, such as a checking and/or savings account. Thus, at step 608, the at least one processor may launch a micro app associated with changing the first parameter in the digital record. The processor may launch the micro app when the user selects the interactive element on the GUI. Consistent with disclosed embodiments, the micro app may be configured to change the first parameter based on information associated with a second digital record.

At step 610, the at least one processor may receive a request to change the first parameter in the digital record based on information associated with a second digital record. The processor may change the first parameter in the digital record as described and exemplified elsewhere in this disclosure. The second digital record may refer to a second account the user may have, wherein the second account is hosted by the same system as the first digital record. In this example, the second digital record may refer to a savings account located at the same bank as the user's checking account. Here, the user may deposit funds in the user's checking account based on funds transferred from the user's savings account. Depositing funds in the user's checking account may change the first parameter, thereby clearing the second flag and removing the interactive element from the GUI.

In one example, a user may have an unfunded account, wherein the numerical value associated with the digital record is 0. The user may deposit funds in their account associated with the digital record using a second account associated with a second digital record. In this example, the user deposits $5.00 from the second account associated with the second digital record. The processor may be configured to register the change in the first parameter based on the second account associated with the second digital record, and may update the numerical value associated with the first digital record from 0 to 5.

In some embodiments, changing the first parameter based on information associated with a second digital record may involve a user transferring funds from their savings account to their checking account. The at least one processor may be configured to retrieve information from the at least one memory, wherein the memory may be associated with the user's mobile device, a remote physical server, and/or a cloud-based server. The user's mobile device may communicate with the remote physical server and/or cloud-based server via a network. In one example, memory is associated with the user's mobile device. The memory may contain information pertaining to both the first digital record and the second digital record, such as the user's account balance. The at least one processor may be configured to direct the user to an internal transfer screen. The internal transfer screen may refer to a second GUI that provides display options for a user to change the first parameter in the first digital record. Thus, at step 612, the at least one processor may direct the user to an internal transfer screen.

At step 614, the at least one processor may receive a request to return to the account home page. In one example, the user may interact with a home button on the user's mobile device or may select a back button in the user's web browser. At step 616, the at least one processor may direct the user back to the user's account home page.

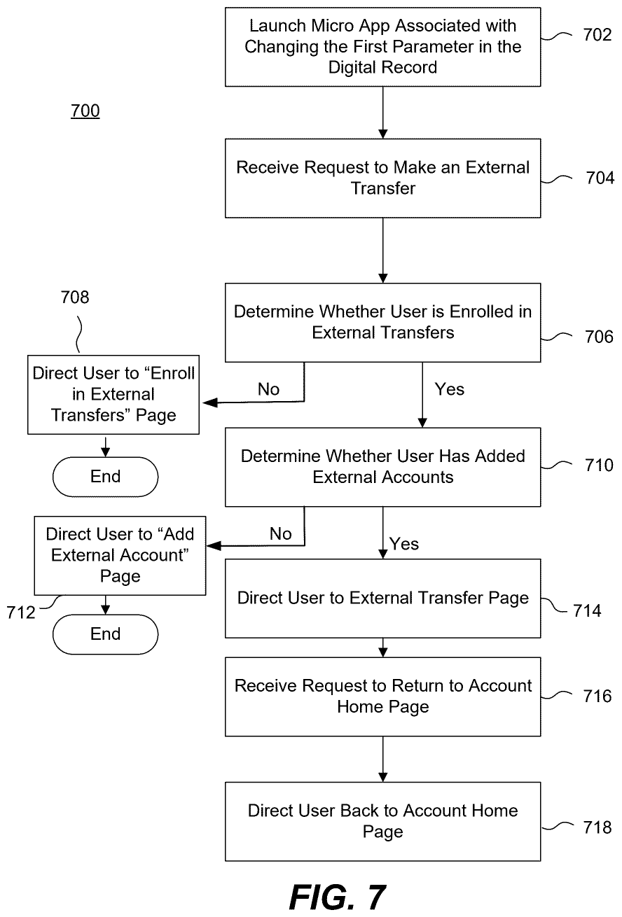

By way of example, FIG. 7 is a flowchart depicting an exemplary method 700 for launching a micro app associated with a user interface, wherein the second digital record is associated with a third-party system, consistent with disclosed embodiments. References to components discussed with respect to FIG. 3 are incorporated herein. References to GUI elements discussed with respect to FIG. 4 are also incorporated herein. At step 702, the processor may launch a micro app associated with changing the first parameter in the digital record, as described at step 508 in relation to FIG. 5.

In some embodiments, the second digital record may be associated with a third-party system, while in some embodiments the second digital record may be associated with the user's primary financial institution. A third-party system may refer to hardware, software, and associated functionalities that are not affiliated or associated with a primary system or financial institution. A third-party system may refer to a financial institution, brokerage house, and/or clearinghouse that is not associated with the first digital record. For example, the primary system may be the user's primary financial institution. Here, the third-party system may be an investment account or a brokerage account. Digital record information related to the third-party system may be stored on the user's mobile device, a remote physical server, and/or a cloud server. The at least one processor may be configured to retrieve information related to the second digital record, regardless of whether the second digital record is associated with a third-party system or the primary financial institution. The at least one processor may retrieve this information using look up tables, artificial intelligence, a search algorithm, and/or a retrieval algorithm as described and exemplified elsewhere in this disclosure. The micro app may be configured to change the first parameter based on information associated with the second digital record, where the second digital record is associated with a third-party system. In one example, the micro app may be configured to change the first parameter based on information the at least one processor retrieves from the user's brokerage account or other account outside the user's primary financial institution. In this example, the user may transfer money from a brokerage account to their checking account. The user may then make a deposit in their checking account. Making this deposit may change the first parameter associated with the digital record, thus clearing the second flag and removing the interactive element from the GUI. As described elsewhere in this disclosure, changing the first parameter associated with the digital record may update a numerical value stored on the digital record.

At step 704, the at least one processor may receive a request to make an external transfer. An external transfer may refer to a transfer from the third-party system or institution to the primary system or institution. The external transfer may be from a checking, savings, and/or brokerage account that the user has at a third-party financial institution. The external transfer may update the digital record, such that the transferred funds are sufficient to change the first parameter. The mobile device may communicate with the server, which, in this example, contains the digital record. The external transfer may cause the at least one processor to execute instructions to change the first parameter in the digital record, thereby clearing the second flag and removing the interactive element from the GUI, as described and exemplified elsewhere in this disclosure.

At step 706, the processor may determine whether the user is enrolled in external transfer. The processor may determine whether the user is enrolled in external transfer by retrieving the user's information from the memory. The processor may also retrieve data using artificial intelligence or a searching algorithm, as described and exemplified elsewhere in this disclosure. The user's external transfer enrollment status may be stored in the memory. Additionally or alternatively, the user's external transfer enrollment status may be stored in a memory associated with the remote server. In one example, the user may be enrolled in external transfers by default. In another example, the user may need to opt in to external transfers. If the user is not enrolled in external transfers, the at least one processor may direct the user to enroll in external transfers at step 708. The processor may direct the user to enroll in external transfers by providing for display an interactive element on the GUI. In this example, method 700 may end until the processor subsequently receives a request to launch a micro app associated with changing the first parameter in the digital record.

If the user has enrolled in external transfers, the at least one processor may determine whether the user has added external accounts at step 710. Consistent with disclosed embodiments, user information, including whether the user has added external accounts, may be stored in memory. The processor may be configured to retrieve this information from memory. The at least one processor may determine that the user has not added external accounts, and the at least one processor may direct the user to add an external account at step 712. The processor may direct the user to add an external account by providing for display an interactive element on the GUI, as described and exemplified elsewhere in this disclosure. In this example, method 600 may end until the processor subsequently receives a request to launch a micro app associated with changing the first parameter in the digital record.

At step 716, the at least one processor may receive a request to return to the account home page. In this example, the at least one processor may receive a request to select a back button in a browser window, regardless of whether the at least one processor directs the user to add an external account at step 712 or directs the user to the external transfer page at step 714. At step 718, the at least one processor may direct the user back to the account home page.

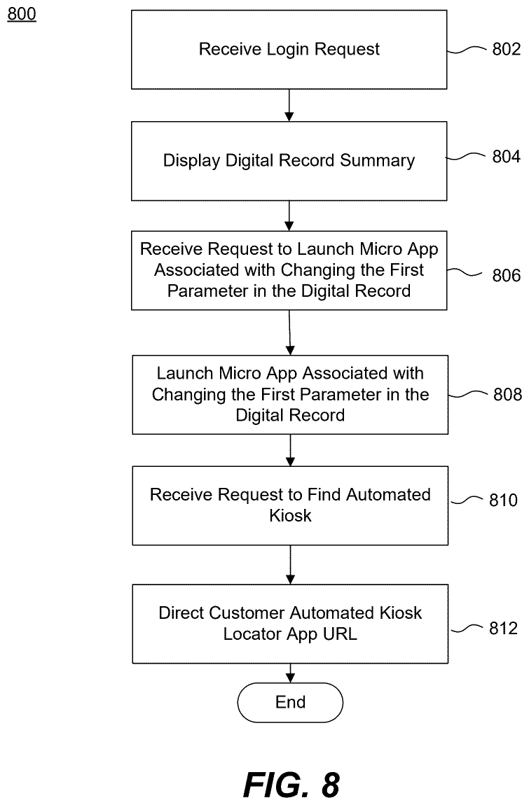

By way of example, FIG. 8 is a flowchart depicting an exemplary method for launching a micro app, wherein the at least one processor is further configured to determine a current location of the mobile device and display locations of one or more automated kiosks, consistent with disclosed embodiments. References to components discussed with respect to FIG. 3 are incorporated herein. References to GUI elements discussed with respect to FIG. 4 are also incorporated herein. Method 800 may include step 802, wherein the at least one processor receives a user's login request. At step 804, the at least one processor may be configured to display the user's digital record summary. The processor may be configured to display the user's digital record on the GUI, as described and exemplified elsewhere in this disclosure. At step 806, the at least one processor may receive a request to launch the micro app associated with changing the first parameter in the digital record. At step 808, the at least one processor may launch the micro app associated with changing the first parameter in the digital record.

At step 810, the at least one processor may receive a request to find an automated kiosk within a predetermined proximity of the current location. In some embodiments, the at least one processor may be further configured to determine a current location of the mobile device. In one example, the at least one processor may determine a current location of the mobile device based on the mobile device's geolocation. In another example, the at least one processor may determine the current location of the mobile device based on user input.

At step 812, the at least one processor may direct the user to an automated kiosk locator micro app. In one example, the automated kiosk locator micro app may be part of the GUI. In another example, the automated kiosk locator micro-app may be a separate URL or web address, and may be accessible via a separate webpage. The at least one processor may be further configured to display, on the user interface, one or more locations of one or more automated kiosks within a predetermined proximity of the current location. An automated kiosk may be an ATM. Predetermined proximity may refer to a set geographic area surrounding the user, based on the current location of the user's mobile device. In this example, rather than change the first parameter of the digital record based on information associated with a second digital record, the at least one processor may be configured to assist the user with finding an automated kiosk (such as, for example, an ATM), so that the user can deposit cash to change the first parameter in the digital record. In one example, the predetermined proximity may be set by the financial institution. In this example, the predetermined proximity may be programmed into the memory of one or more servers associated with the disclosed system. For example, the financial institution may set the predetermined proximity at 1 mile from the user's current location. In another example, the predetermined proximity may be set by the user. The user may also select the predetermined proximity from a list of options. The predetermined proximity options may be 0.25 miles, 0.5 miles, 1 mile, 2 miles, 5 miles, or any other distance set by the financial institution or the user.

In yet another example, the at least one processor may display the nearest 5, 10, 15, or 20 automated kiosks regardless of the predetermined proximity. In this example, the predetermined proximity may be within 5 miles of the user. Here, the at least one processor may display the closest 10 automated kiosks, even if one or more of the automated kiosks lies outside the 5-mile predetermined proximity. The user may deposit a check via an automated kiosk. The user depositing the check may cause the processor to execute instructions to change the first parameter in the digital record, thereby clearing the second flag and removing the interactive element from the GUI.

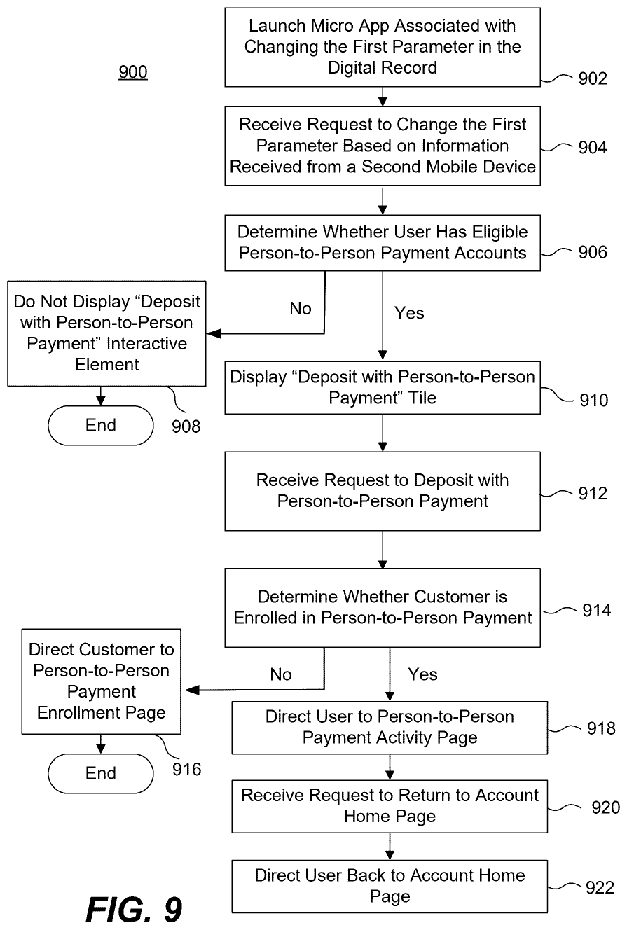

By way of example, FIG. 9 is a flowchart depicting an exemplary method 900 for launching a micro app, wherein the micro app is configured to change the first parameter based on information received from a second mobile device, consistent with disclosed embodiments. References to components discussed with respect to FIG. 3 are incorporated herein. References to GUI elements discussed with respect to FIG. 4 are also incorporated herein.

At step 902, the processor may launch a micro app associated with changing the first parameter in the digital record, as described at step 508 in relation to FIG. 5. At step 904, the at least one processor may receive a request to change the first parameter in the digital record based on information received from a second mobile device. The request may involve making a deposit to the user's account via a person-to-person payment. A person-to-person payment may refer to transferring funds between two users without involving an intermediary such as a bank or credit card company. The second mobile device may refer to a smartphone, smartwatch, tablet, or laptop, owned by a second user, and the second mobile device may be configured to transfer information to the first user's mobile device. The second mobile device user may send the first user funds via a third-party payment platform. The first user may then use the funds received via the second mobile device to update the first parameter in the digital record.

In some embodiments, the second mobile device may provide information via Near Field Communication (NFC). NFC may refer to a set of short-range wireless technologies and/or protocols that permit communication between two electronic devices when they are located close to one another. In addition to NFC, the second mobile device may provide information to the first mobile device via WiFi (IEEE 802.11-based), radio frequency (RF, such as ZigBee or ZWave), radio frequency identification (RFID, such as Active Reader Passive Tag or Active Reader Active Tag), Bluetooth, or any other wireless pairing protocol usable for short-range communication. For example, a second mobile device user may position the second mobile device such that it is within 10 cm of the first mobile device. In another example, the second mobile device user may position the second mobile device such that it touches the first mobile device. In this example, the second mobile device user may transfer funds to the first mobile device user, and the user's account, using one or more NFC payment methods such as a mobile wallet, PayPal, Square, Apple Pay, Samsung Pay, Google Pay, and/or contactless cards. NFC payments may encrypt transaction information, making each transaction more secure. Transferring funds from the second mobile device to the user's account may cause the processor to execute instructions to change the first parameter in the digital record, thereby clearing the second flag and removing the interactive element from the GUI, as described and exemplified elsewhere in this disclosure.

At step 906, the at least one processor may determine whether the user has eligible person-to-person payment accounts. The user's person-to-person payment accounts, if applicable, may be stored in memory. The processor may determine that the user has eligible person-to-person payment accounts if they are available for processor to retrieve from memory. In this example, the at least one processor may determine whether the user has eligible third-party payment accounts. The at least one processor may make this determination using a look up table or artificial intelligence. The user may change a first parameter in the digital record based on funds received from a second mobile device, thereby clearing the second flag, as described and exemplified elsewhere in this disclosure. Clearing the second flag may remove the interactive element from the GUI.

At step 908, the at least one processor may determine that the user does not have any eligible person-to-person payment accounts, and therefore may not display a “deposit with person-to-person payment” interactive element. For example, the at least one processor may determine that the user does not have Zelle or CashApp. In this example, processor may receive a request to retrieve from memory Zelle or CashApp account information from the memory, and that memory may not contain that information. Method 900 may end if the processor determines that the user does not have any eligible person-to-person payments.

At step 910, the at least one processor may determine that the user has at least one eligible person-to-person payment account, and may display on the GUI a “deposit with person-to-person payment” interactive element at step 910. At step 912, the at least one processor may receive a request to change the first parameter based on information received from a second mobile device, i.e., make a deposit using a person-to-person payment. At step 914, the at least one processor may determine whether the user has enrolled in person-to-person payments. The at least one processor may perform the determining step by retrieving from memory person-to-person enrollment information. The at least one processor may determine that the user has eligible person-to-person payment accounts, but has not enrolled in person-to-person payments. The at least one processor may thus direct the user to the person-to-person payment enrollment page at step 916. The at least one processor may determine that the user has enrolled in person-to-person payments, and may direct the user to a person-to-person payment activity page at step 918. The at least one processor may determine whether the user has enrolled in person-to-person payments by retrieving that stored information from memory, such as a memory associated with a server. The user may fund their account using a person-to-person payment. At step 920, the at least one processor may receive a request to return to the account home page. In one example, the user may select a back button in the user's internet browser. In another example, the user may select a home button on the user's mobile device. At step 922, the at least one processor may direct the user back to the account home page.

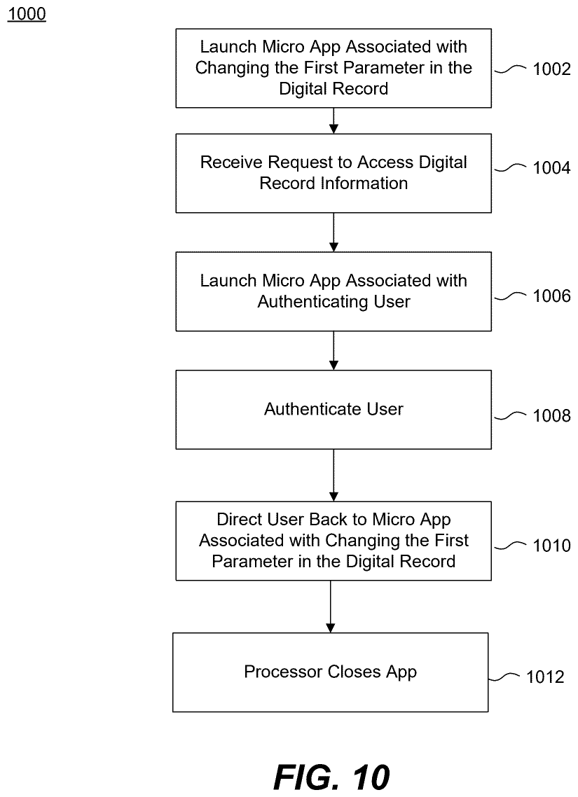

By way of example, FIG. 10 is a flowchart depicting an exemplary method 1000 for a user to access digital record information. References to components discussed with respect to FIG. 3 are incorporated herein. References to GUI elements discussed with respect to FIG. 4 are also incorporated herein. At step 1002, the processor may launch a micro app associated with changing the first parameter in the digital record, as described at step 508 in relation to FIG. 5. At step 1004, the at least one processor may receive a request to access digital record information. The at least one processor may receive a request to access digital record information when the user clicks on the accounts menu as described in reference to FIG. 4. The at least one processor may then retrieve the digital record information from the at least one memory associated with the user's mobile device, a memory associated with a remote server, and/or a cloud server. The user's mobile device may communicate with the remote server via a network. At step 1006, the at least one processor may launch a micro-application associated with authenticating the user. At step 1008, the at least one processor may be configured to authenticate a user. Authentication may include a multifactor authentication process such as a username and password, a biometrics login, two-factor authentication, login through a third-party wallet provider, or authentication using a plug in. After the user has been successfully authenticated, at step 1010, the at least one processor may direct the user back to the GUI, wherein the user may launch the micro app associated with changing the first parameter in the digital record. Alternatively, the user may not be successfully authenticated, and may be prompted to re-enter their log-in credentials. At step 1012, the at least one processor may receive a request to close out of the user's mobile banking app.

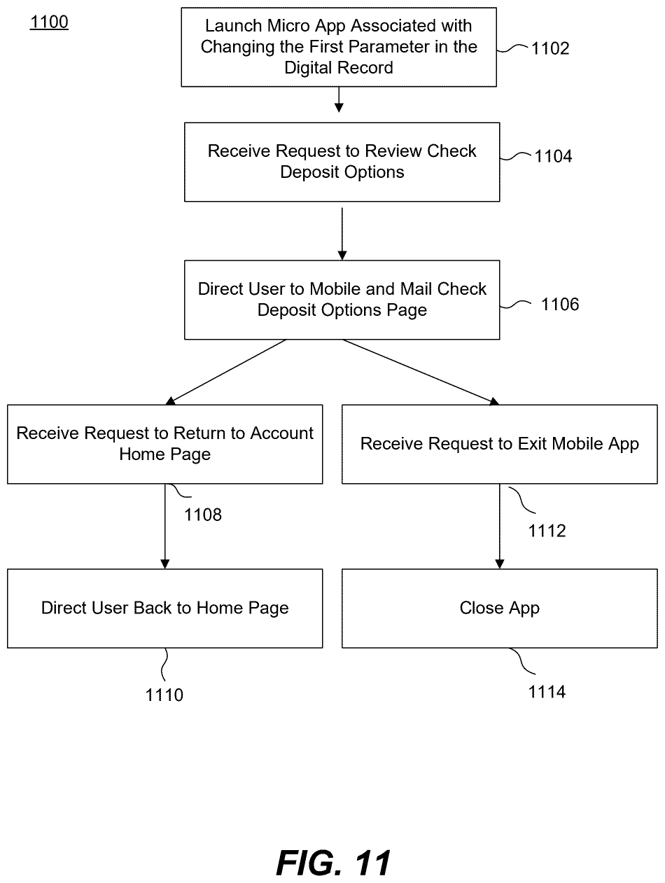

By way of example, FIG. 11 is a flowchart depicting an exemplary method 1100 for a user to review their check deposit options, consistent with disclosed embodiments. References to components discussed with respect to FIG. 3 are incorporated herein. References to GUI elements discussed with respect to FIG. 4 are also incorporated herein. At step 1102, the processor may launch a micro app associated with changing the first parameter in the digital record, as described at step 508 in relation to FIG. 5. At step 1104, the at least one processor may receive a request to review check deposit options. The user may review check deposit options via the account home page. At step 1106, the at least one processor may direct the user to a mobile and mail check deposit options webpage. The mobile and mail check deposit options webpage may be a separate URL or webpage, or it may be a micro app within the GUI accessible via the accounts home page. The user may have the option to deposit a check via mobile remote deposit. The at least one processor may also direct the user to deposit a check via a nearby ATM. In yet another example, the at least one processor may present an option for the user to deposit a check by mail. The user may select one or more of the check deposit options. Consistent with disclosed embodiments, depositing a check may change the first parameter associated with the digital record. At step 1108, the at least one processor may receive a request to return to the account home page. At step 1110, the at least one processor may direct the user may to the account home page. Alternatively, at step 1112, the at least one processor may receive a request to exit the mobile app or webpage. In this example, the at least one processor may close the app and/or webpage at step 1114. Depositing the check may change the first parameter in the digital record 1112, thereby clearing the second flag and removing the interactive element from GUI 400.

The descriptions of the various embodiments of the present disclosure have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

It is appreciated that certain features of the disclosure, which are, for clarity, described in the context of separate embodiments, may also be provided in combination in a single embodiment. Conversely, various features of the disclosure, which are, for brevity, described in the context of a single embodiment, may also be provided separately or in any suitable sub-combination or as suitable in any other described embodiment of the disclosure. Certain features described in the context of various embodiments are not to be considered essential features of those embodiments, unless the embodiment is inoperative without those elements.

Although the disclosure has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

What is claimed is:

1. A system for launching a micro app associated with a user interface, the system comprising:
a memory storing instructions; and
at least one processor configured to execute the stored instructions to:
associate a digital record with a unique identifier of a mobile device connected to a network;
provide for display, on the mobile device, a user interface associated with the digital record;
determine an age of the digital record;
set a first flag responsive to a determination that the age of the digital record exceeds a first threshold;
set a second flag responsive to a determination that a first parameter in the digital record is beneath a second threshold;
responsive to the first flag and the second flag:
display, on the user interface, an interactive element for launching a micro app associated with changing the first parameter, wherein the interactive element persists within the user interface until:
the at least one processor detects a user selection of the interactive element, and the second flag is cleared; or
the at least one processor determines that the age of the digital record exceeds a third threshold higher than the first threshold; and
responsive to a determination that the age of the digital record exceeds a fourth threshold higher than the third threshold and the second flag remains set, terminate the digital record.

2. The system of claim 1, wherein the fourth threshold and the third threshold have the same value.

3. The system of claim 1, wherein the micro app is configured to change the first parameter based on information associated with a second digital record.

4. The system of claim 3, wherein the second digital record is associated with a third party system.

5. The system of claim 1, wherein the at least one processor is further configured to:
determine a current location of the mobile device; and
display, on the user interface, one or more locations of one or more automated kiosks within a predetermined proximity of the current location.

6. The system of claim 1, wherein the micro app is configured to change the first parameter based on information received from a second mobile device.

7. The system of claim 6, wherein the second mobile device provides information via Near Field Communication (NFC).

8. A method for launching a micro app associated with a user interface, the method comprising:
associating a digital record with a unique identifier of a mobile device connected to a network;
providing for display, on the mobile device, a user interface associated with the digital record;
determining an age of the digital record;
setting a first flag responsive to a determination that the age of the digital record exceeds a first threshold;
setting a second flag responsive to a determination that a first parameter in the digital record is beneath a second threshold;
responsive to the first flag and the second flag:
displaying, on the user interface, an interactive element for launching a micro app associated with changing the first parameter, wherein the interactive element persists within the user interface until:
at least one processor detects a user selection of the interactive element, and the second flag is cleared; or
the at least one processor determines that the age of the digital record exceeds a third threshold higher than the first threshold.

9. The method of claim 8, further comprising:
determining whether the age of the digital record exceeds a fourth threshold higher than the third threshold; and
responsive to a determination that the age of the digital record exceeds a fourth threshold higher than the third threshold and the second flag remains set, terminating the digital record.

10. The method of claim 9, wherein the fourth threshold and the third threshold have the same value.

11. The method of claim 8, further comprising:
changing the first parameter based on information associated with a second digital record.

12. The method of claim 11, wherein the second digital record is associated with a third-party system.

13. The method of claim 8, further comprising:
determining a current location of the mobile device; and
displaying, on the user interface, one or more locations of one or more automated kiosks within a predetermined proximity of the current location.

14. The method of claim 8, wherein the micro app is configured to change the first parameter based on information received from a second mobile device.

15. The method of claim 14, wherein the second mobile device provides information via Near Field Communication (NFC).

16. A non-transitory computer readable medium having stored instructions that when executed cause at least one processor to perform instructions for launching a micro app associated with a user interface, comprising:
associating a digital record with a unique identifier of a mobile device connected to a network;
providing for display, on the mobile device, a user interface associated with the digital record;
determining an age of the digital record;
setting a first flag responsive to a determination that the age of the digital record exceeds a first threshold;
setting a second flag responsive to a determination that a first parameter in the digital record is beneath a second threshold;
responsive to the first flag and the second flag:
displaying, on the user interface, an interactive element for launching a micro app associated with changing the first parameter, wherein the interactive element persists within the user interface until:
the at least one processor detects a user selection of the interactive element, and the second flag is cleared; or
the at least one processor determines that the age of the digital record exceeds a third threshold higher than the first threshold; and
responsive to a determination that the age of the digital record exceeds a fourth threshold higher than the third threshold and the second flag remains set, terminating the digital record.

17. The non-transitory computer readable medium of claim 16, wherein the fourth threshold and the third threshold have the same value.

18. The non-transitory computer readable medium of claim 16, wherein the micro app is configured to change the first parameter based on information associated with a second digital record.

19. The non-transitory computer readable medium of claim 18, wherein the second digital record is associated with a third-party system.

20. The non-transitory computer readable medium of claim 16, wherein the at least one processor further performs instructions comprising:
determining a current location of the mobile device; and
displaying, on the user interface, one or more locations of one or more automated kiosks within a predetermined proximity of the current location.

21. The non-transitory computer readable medium of claim 16, wherein the micro app is configured to change the first parameter based on information received from a second mobile device.

22. The non-transitory computer readable medium of claim 16, wherein a second mobile device provides information via Near Field Communication (NFC).
